(19) United States
(12) Patent Application Publication
(10) Pub. No.: US 2025/0002270 A1
(43) Pub. Date: Jan. 2, 2025

(54) Method And System For Handling Packages

(71) Applicant: Graphic Packaging International, LLC, Atlanta, GA (US)

(72) Inventors: Colin P. Ford, Woodstock, GA (US); Ryan Dye, Marietta, GA (US); Nathan Marquez, Austell, GA (US); Tyler Nelson, Crosby, MN (US)

(21) Appl. No.: 18/758,841

(22) Filed: Jun. 28, 2024

Related U.S. Application Data
(60) Provisional application No. 63/523,796, filed on Jun. 28, 2023.

(51) Int. Cl. B65G 47/96; B65G 17/06; B65G 43/08; B65G 47/38

(52) U.S. Cl. CPC B65G 47/962; B65G 17/065; B65G 43/08; B65G 47/38; B65G 2201/0235

(57) ABSTRACT

A method of handling packages can comprise moving a plurality of slats in a downstream direction so that a portion of each slat passes over an electromagnet. Each slat can be pivotable between a horizontal a tilted position, and the electromagnet can be energized to at least partially hold the slats in the horizontal position. The method further can include positioning a package on one or more slats of the plurality of slats so that the package is moved in the downstream direction on the one or more slats and moving the package off the one or more slats comprising deenergizing the electromagnet while moving the one or more slats past the electromagnet so that the one or more slats pivot from the horizontal to the tilted position so that the package moves off the one or more slats while the slats move in the downstream direction.

### CROSS-REFERENCED TO RELATED APPLICATIONS

This application claims the benefit of U.S. Provisional Patent Application No. 63/523,796, filed on Jun. 28, 2023.

### INCORPORATION BY REFERENCE

The disclosure of U.S. Provisional Patent Application No. 63/523,796, which was filed on Jun. 28, 2023, is hereby incorporated by reference for all purposes as if presented herein in its entirety.

### BACKGROUND OF THE DISCLOSURE

The present disclosure generally relates to systems and methods for handling packages. More specifically, the present disclosure is directed to methods and systems for conveying packages along a product stream and ejecting nonconforming packages from the product stream, for example.

### SUMMARY OF THE DISCLOSURE

In general, one aspect of the disclosure is directed to a method of handling packages. The method can comprise moving a plurality of slats in a downstream direction so that a portion of each slat of the plurality of slats passes over an electromagnet. Each slat of the plurality of slats can be pivotable between a horizontal position and a tilted position, and the electromagnet can be energized to at least partially hold the slats in the horizontal position as the portions of the respective slats move over the electromagnet. The method further can include positioning a package on one or more slats of the plurality of slats so that the package is moved in the downstream direction on the one or more slats and moving the package off the one or more slats comprising deenergizing the electromagnet while moving the one or more slats past the electromagnet so that the one or more slats supporting the package pivot from the horizontal position to the tilted position so that the package moves off the one or more slats while the one or more slats continue to move in the downstream direction.

In another aspect, the disclosure is generally directed to a system for handling packages. The system can comprise a plurality of slats mounted along a conveyor and moving in a downstream direction of the conveyor, each slat of the plurality of slats being pivotable between a horizontal position and a tilted position. An electromagnet can be mounted along a portion of the conveyor so that a portion of each slat passes over the electromagnet as the slats move in a downstream direction. The electromagnet can be operable to be energized to at least partially hold the slats in the horizontal position as the portions of the respective slats move over the electromagnet and to be deenergized to allow pivoting of the slats as the portions of the respective slats move over the deenergized electromagnet. One or more slats of the plurality of slats can support a package as the slats are moved along the conveyor, and the package can move off the one or more slats when the one or more slats are moved into the tilted position.

Additional aspects, features, and advantages of the present invention will become apparent from the following description and accompanying figures.

### BRIEF DESCRIPTION OF THE DRAWINGS

Those skilled in the art will appreciate the above stated advantages and other advantages and benefits of various additional embodiments reading the following detailed description of the embodiments with reference to the below-listed drawing figures. It is within the scope of the present disclosure that the above-discussed aspects be provided both individually and in various combinations.

According to common practice, the various features of the drawings discussed below are not necessarily drawn to scale. Dimensions of various features and elements in the drawings may be expanded or reduced to more clearly illustrate the embodiments of the disclosure.

FIG. 1A is a perspective view of a package including a carton according to exemplary embodiments of the disclosure.

FIG. 1B is a perspective view of a package including a nonconforming carton according to exemplary embodiments of the disclosure.

FIGS. 2A and 2B are perspective views of a system and method for handling the packages of FIGS. 1A and 1B according to exemplary embodiments of the disclosure.

FIGS. 3A and 3B are perspective views of the system with parts removed to show internal feature of the system according to exemplary embodiments of the disclosure.

FIG. 3C is a cross-sectional view of the system taken at line 3C in FIG. 3A.

FIG. 4A is a cross-sectional view of the system as shown in FIG. 3C with slats that are in a tilted configuration according to exemplary embodiments of the disclosure.

FIG. 4B is a perspective view of the system with parts removed and with the slats in the tilted configuration according to exemplary embodiments of the disclosure.

FIG. 5 is a perspective view of the system and method of FIGS. 2A and 2B during a rejections sequence with slats in the tilted configuration according to exemplary embodiments of the disclosure.

FIG. 6 is a perspective view of a portion of the system of FIG. 5 showing tilted slats being moved to the horizontal configuration according to exemplary embodiments of the disclosure.

Corresponding parts are designated by corresponding reference numbers throughout the drawings.

### DETAILED DESCRIPTION OF THE EXEMPLARY EMBODIMENTS

The present disclosure generally relates to a system and method of handling packages that can include cartons (e.g., fully enclosed cartons, at least partially closed cartons, etc.), carriers (e.g., basket-style carriers, wrap around carriers, etc.), and/or other suitable constructs holding containers or other articles. The containers can be used for packaging food and beverage products, for example. The containers can be made from materials suitable in composition for packaging the particular food or beverage item, and the materials include, but are not limited to, glass; aluminum and/or other metals; plastics such as PET, LDPE, LLDPE, HDPE, PP, PS, PVC, EVOH, and Nylon; and the like; or any combination thereof. Cartons and/or other constructs according to the present disclosure can accommodate containers of numerous different shapes. For the purpose of illustration and not for the purpose of limiting the scope of the disclosure, the following detailed description describes beverage containers (e.g., aluminum cans, glass bottles, etc.) at least partially disposed within the cartons and/or other constructs. In this specification, the terms “lower,” “bottom,” “upper,” “top,” “front,” and “back” indicate orientations determined in relation to fully erected cartons.

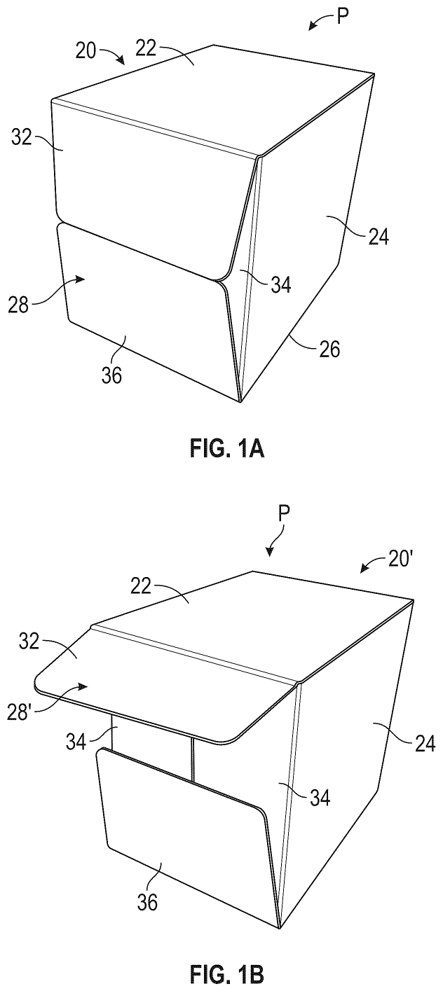

As shown in FIG. 1A, the packages P can include a carton 20 (e.g., a fully enclosed carton) holding containers (not shown) such as bottles (e.g., glass, plastic, aluminum, etc.) or cans. The carton 20 can be sized and shaped to hold any suitable number of containers arranged in any suitable configuration. For example, the carton 20 can be sized to house fifteen containers in a single layer in a 3×5 arrangement, ten containers in a 2×5 arrangement, nine containers in a 3×3 arrangement, four containers in a 2×2 arrangement, etc. Further, it is understood that the carton 20 may be sized and shaped to hold containers of a different or same quantity in more than one layer and/or in different row/column arrangements (e.g., 1×6, 2×6, 4×6, 3×8, 2×6×2, 3×4×2, 2×9, 3×6, etc.), or just a single article.

In the illustrated embodiment, the carton 20 can include a top panel 22, opposing side panels 24, and a bottom panel 26 opposite to the top panel 22. Respective ends 28 of the carton can be at least partially closed by a top end flap 32 foldably connected to the top panel 22, side end flaps 34 foldably connected to the respective side panels 24, and a bottom end flap 36 foldably connected to the bottom panel 26. As shown in FIG. 1, the end flaps 32, 34, 36 can be overlapped to close the end 28. For example, the side end flaps 34 can be folded over the open end of the carton 20 after loading containers into an interior of the carton, the bottom end flap 36 can be folded upwardly to overlap the side end flaps 34, and the top end flap 32 can be downwardly folded to overlap the side end flaps 34 and the bottom end flap 36. In embodiments, the side end flaps 34 can be glued to the top end flap 32 and/or the bottom end flap 36, and the lower marginal portion of the top end flap 32 can be glued to the upper marginal portion of the bottom end flap 36. Any of the panels, flaps, fold lines, and/or other features of the carton 20 and/or the package P could be omitted or could be otherwise shaped, arranged, positioned, and/or configured without departing from the disclosure. Further, the carton 20 and the package P could be otherwise formed without departing from the disclosure.

In embodiments, the carton 20 can be erected and loaded with containers and the ends 28 of the carton 20 can be glued and closed to form the package P by a packaging system (not shown). In exemplary embodiments, the packaging system can discharge the packages P at a high rate of speed (e.g., at over 250 packages per minute, over 350 packages per minute, or other high rates) or at any suitable speed. Occasionally, the packaging system can output a malformed or nonconforming carton 20′. For example, one or more end flaps 32, 34, 36 of the nonconforming carton 20′ may be improperly glued so that one or more ends 28′ of the nonconforming carton 20′ are not properly closed. For example, as shown in FIG. 1B, the top end flap 32 of the nonconforming carton 20′ is not glued to the bottom end flap 36 and is extending outwardly from the end 28′ rather than being folded into an overlapping relationship with the side end flaps 34 and the bottom end flap 36. In embodiments, it is desirable to remove nonconforming packages from the output stream of the packaging system while allowing properly formed packages to continue in the output stream. The rejected packages can be recovered so that issues can be corrected, the package can be discarded, the containers can be returned to the container input of the packaging system, etc.

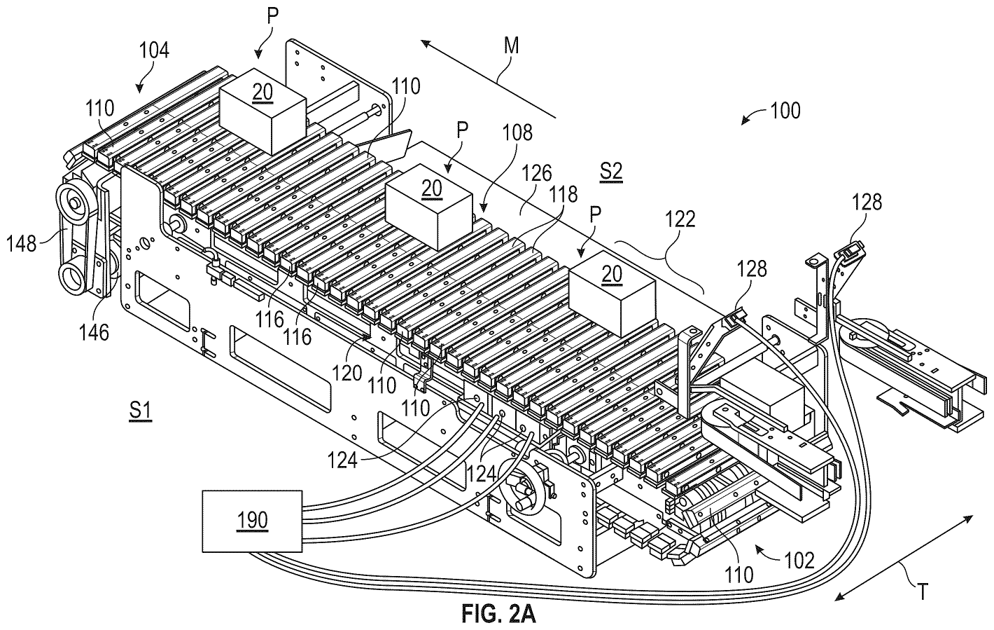

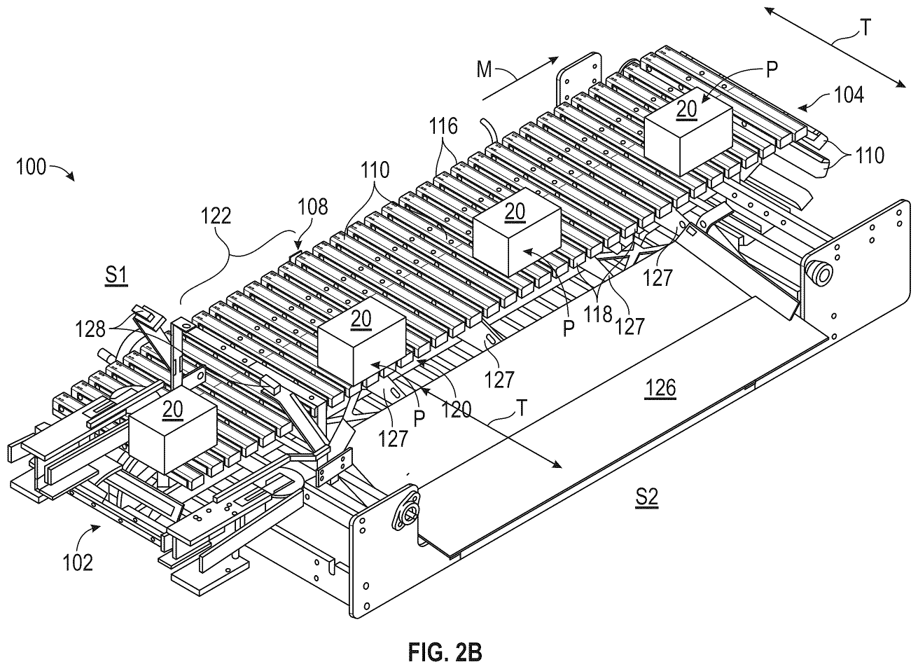

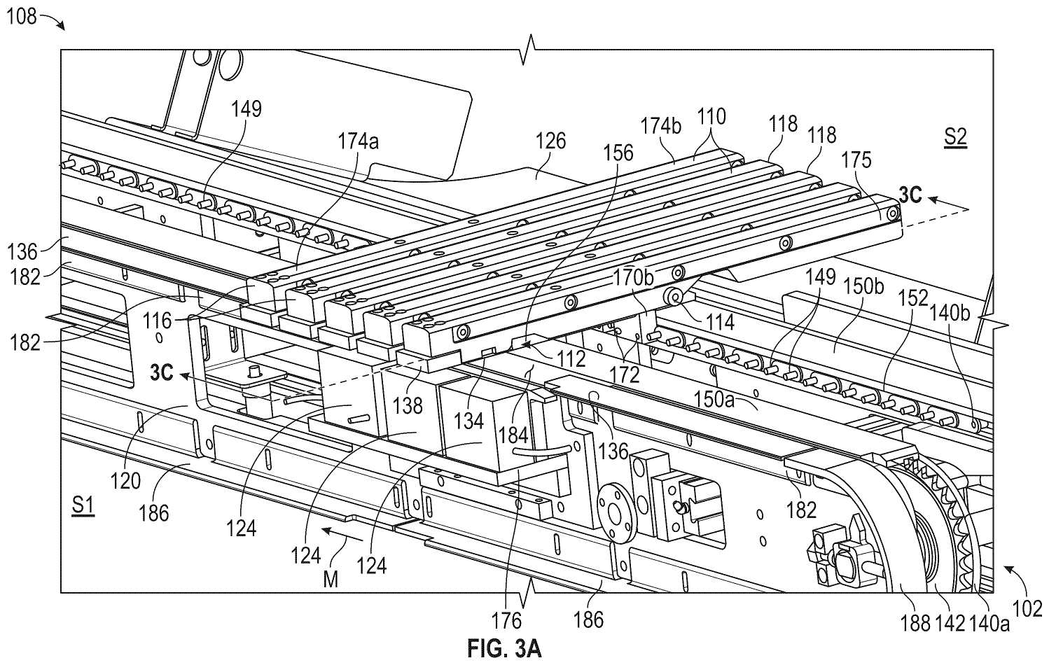

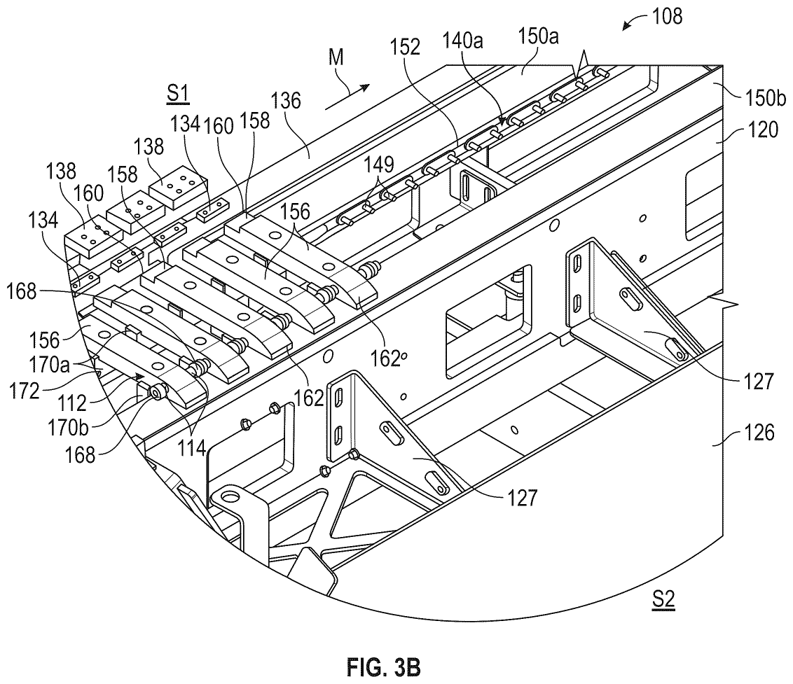

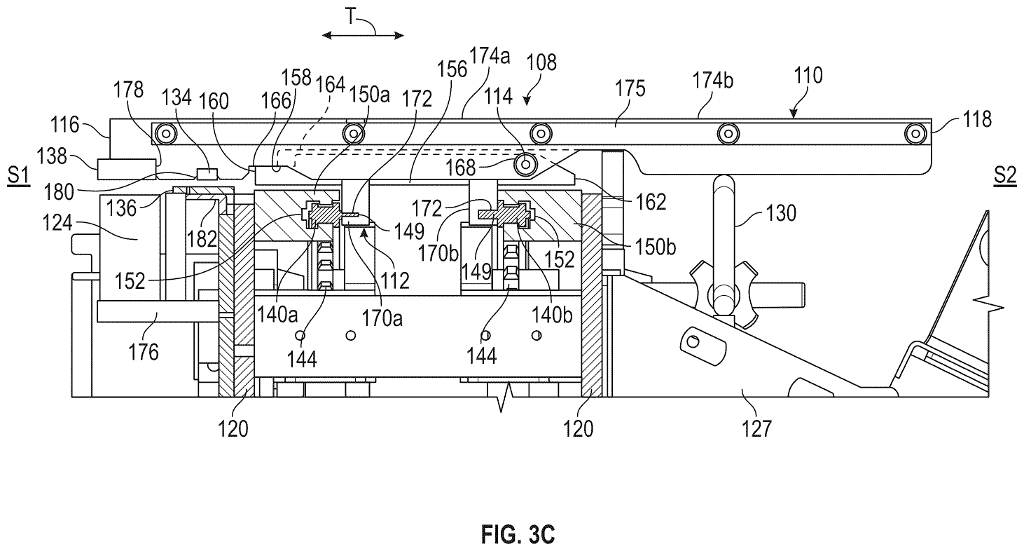

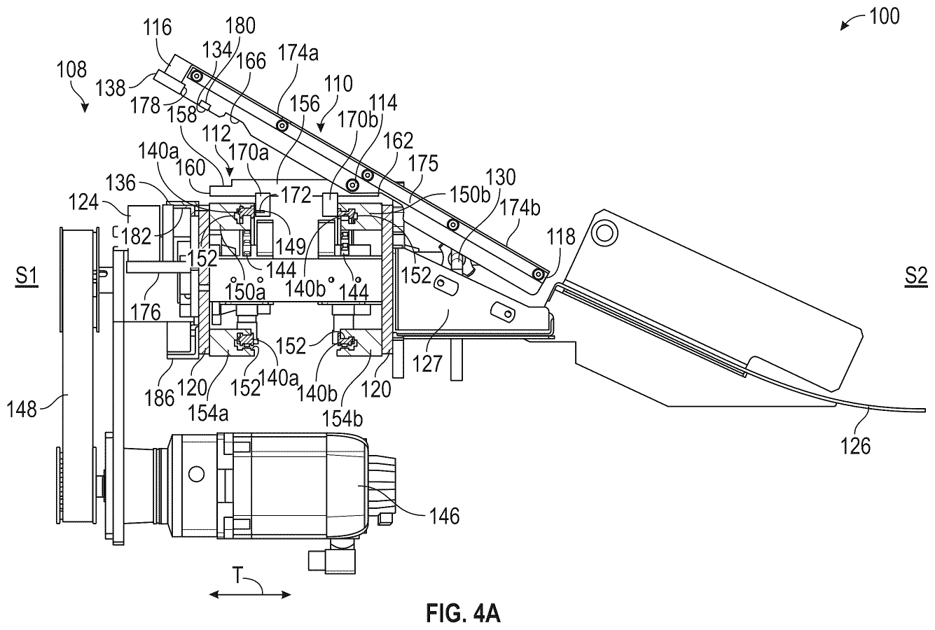

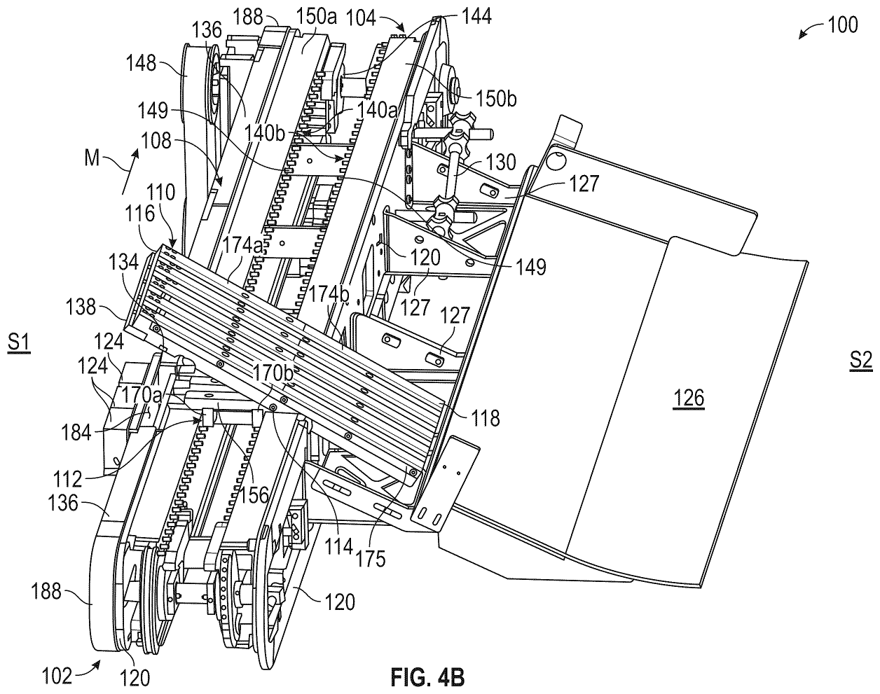

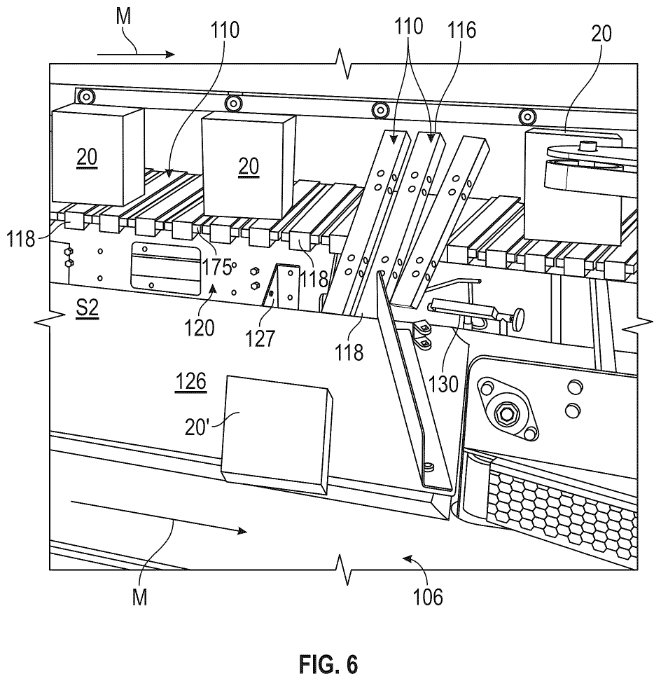

As shown in FIGS. 2A and 2B, a package reject system 100 can receive packages P (e.g., from a packaging system, not shown) at an upstream end or input end 102 of the system 100 and can move the packages P along a machine direction M (e.g., downstream direction) to a downstream end or output end 104, while selectively moving packages P (e.g., with malformed cartons 20′) to a take-away conveyor 106 (FIG. 6). In the illustrated embodiments, the system 100 can include an endless conveyor 108 including a plurality of slats 110 mounted along the conveyor 108, each of the slats 110 having a length extending in a lateral or transverse direction T (e.g., perpendicular to the machine direction M). As shown in FIGS. 3A-4B, the slats 110 are respectively mounted on a plurality of mount assemblies 112, which can support the slats 110 and move the slats 110 in the machine direction M on a top side of the conveyor 108 from the upstream end 102 to the downstream end 104 and can return the slats 110 from the downstream end 104 to the upstream end 102 under the conveyor 108. As described in more detail below, the slats 110 can be pivotably mounted on the respective mount assemblies 112 such as by one or more pivot pins 114 so that the individual slats 110 can pivot between a horizontal position (FIGS. 3A and 3C) and a tilted position (FIGS. 4A and 4B). In embodiments, the slats 110 can be held in the horizontal position by holding features, such as an interaction (e.g., magnetic attraction/engagement) of one or more permanent magnets 134 and one or more ferromagnetic plates 136 and/or an interaction (e.g., magnetic attraction/engagement) of one or more electromagnets 124 and one or more ferromagnetic bars 138, wherein the electromagnets 124 can be selectively deactivated for freeing the slats 110 from being held in the horizontal position. In the illustrated embodiments, the conveyor 108 can have a first side S1 with the holding features that determine whether the individual slats 110 are held in the horizontal position or are free to pivot on the respective mount assemblies 112 and a second side S2 with features for receiving packages P that are moved off the conveyor 108 (e.g., packages P with nonconforming cartons 20′), as described in more detail below.

As shown in FIGS. 3A-3C, the conveyor 108 includes two chains 140a, 140b moving along respective upstream wheels 142 and respective downstream wheels 144 (FIGS. 3C-4B) mounted to two frame plates 120, which can be spaced from one another in the transverse direction T, and which can have lengths extending in the machine direction M. In embodiments, the frame plates 120 can be mounted opposite to one another along the length of the conveyor 108. The frame plates 120 can be mounted to a support structure (not shown), such as on legs, an outer frame, and/or other suitable support elements. In embodiments, the downstream wheels 144 can be driven by a motor 146 (FIGS. 2A and 4A) and/or another suitable drive, such as via a drive belt 148 or other suitable features (e.g., gears, etc.), to move the respective chains 140a, 140b over the wheels 142, 144 so that the chains 140a, 140b move from the upstream wheels 142 in the downstream direction M along the top of the conveyor 108, over the downstream wheels 144, and then back to the upstream wheels 142 along the bottom of the conveyor 108 in the opposite direction to the downstream direction M. As shown in FIGS. 3A-3C, each of the chains 140a, 140b can have a plurality of mounting posts 149 extending inwardly (e.g., towards a center of the conveyor 108) from the respective chains 140a, 140b for at least partially supporting the mount assemblies 112, as discussed in more detail below.

In the illustrated embodiments, the chains 140a, 140b can move along respective chain guides 150a, 150b mounted to the respective frame plates 120 along the top of the conveyor 108. As shown in FIGS. 3A-3C, each of the chain guides 150a, 150b can include a recess or groove 152 extending along the length of the respective chain guide 150a, 150b for at least partially receiving the respective chains 140a, 140b and for holding the respective chains 140a, 140b in place vertically and/or horizontally as the chains 140a, 140b move in the downstream direction M along the respective grooves 152. In embodiments, the chain guides 150a, 150b can help the chains 140a, 140b support the weight of the mount assemblies 112, the slats 110, and the packages P carried on the slats 110. As shown in FIG. 4A, lower chain guides 154a, 154b can be mounted to the frame plates 120 along the bottom of the conveyor 108 for supporting/guiding the respective chains 140a, 140b as they are moved toward the upstream wheels 142 along the bottom of the conveyor 108. In embodiments, the lower chain guides 154 can be similarly configured or identical to the chain guides 150a, 150b. The chains 140a, 140b, the chain guides 150a, 150b, 154a, 154b, and/or other associated features could be omitted or could be otherwise shaped, positioned, arranged, and/or configured without departing from the disclosure.

As shown in FIGS. 3A-4B, each of the slats 110 can be pivotably mounted to the respective mount assemblies 112 by the one or more pivot pins 114 located between a first end 116 of the slat 110 on the first side S1 of the system 100 and a second end 118 of the slat 110 on the second side S2 of the system 100. In the illustrated embodiments, each of the mount assemblies 112 can include a slat mount 156 having a length that extends transverse to the machine direction M. As shown in FIGS. 3B-4B, the slat mount 156 can have a recessed slat support surface 158 at a first end 160 (e.g., closer to the first side S1 of the system 100) and a curved or sloped second end 162 (e.g., closer to the second side S2 of the system 100). As shown in FIG. 3C, the slat mount 156 can be partially received in a slat recess 164 with the edges of the slat recess 164 and the slat mount 156 shown in broken lines. For example, the slat recess 164 can provide clearance for the portion of the slat mount 156 that is received in the slat recess 164 so that the slat 110 can move onto and off of a portion of the slat mount 156 (e.g., the slat mount 156 can move into and out of the slat recess 164) as the slat 110 pivots about the pivot pins 114. As shown in FIGS. 3C and 4A, a stop surface 166 can extend from the slat recess 164 toward the first end 116 of the slat 110 for engaging (e.g., overlapping and/or contacting) the slat support surface 158 at the first end 160 of the slat mount 156. In exemplary embodiments, the slat support surface 158 and the stop surface 166 can be aligned with the axis of the pivot pins 114 (e.g., the interface between the slat support surface 158 and the stop surface 166 when the slat 110 is in the horizontal position generally can be coplanar with the axis of the pivot pins 114) or can be in any suitable position for stopping downward pivoting of the first end 116 of the slat 110. The slat support surface 158 of the slat mount 156 and the stop surface 166 of the slat 110 can contact one another when the slat 110 is in the horizontal position for resisting and/or preventing downward pivoting of the first end 116 of the slat 110 past the horizontal position shown in FIG. 3C.

In the illustrated embodiments, the pivot pin 114 can extend through the walls of the slat 110 extending along the slat recess 164 and through the slat mount 156 proximate the second end 162 of the slat mount 156. For example, the pivot pin 114 can be a single pin that extends through the slat 110 and the slat mount 156 or could be two pivot pins 114 extending through opposite sides of the slat 110 and mounted to the slat mount 156 therebetween. In embodiments, the pivot pins 114 can include end caps 168 to help prevent side-to-side movement of the slats 110 relative to the slat mounts 156. In exemplary embodiments, the pivot pins 114 can be posts that the slats can pivot about and/or can include bearings and/or other suitable features for facilitating pivoting of the slat 110 relative to the slat mount 156.

As shown in FIGS. 3A-3C, each of the slat mounts 156 can be mounted on two chain lugs 170a, 170b (e.g., with mechanical fasteners, adhesive, and/or other suitable fastening features), and the chain lugs 170a, 170b are engaged with the respective chains 140a, 140b below the slat mount 156. In embodiments, each of the chain lugs 170a, 170b can have two or any suitable number of bores 172 extending through the respective lug in the horizontal direction, transverse to the machine direction M. In the illustrated embodiments, each of the bores 172 can receive a respective mounting post 149 extending from the respective chain 140a, 140b. In exemplary embodiments, the connection of the chain lugs 170a, 170b to the slat mount 156 can prevent the chain lugs 170a, 170b from moving off the mounting posts (e.g., transverse to the machine direction M) so that the chain lugs 170a, 170b remain engaged with the chains 140a, 140b once the mount assembly 112 is assembled. In other embodiments, the chain lugs 170a, 170b could be mounted to the mounting posts 149 by mechanical fasteners, adhesive, interference fits, etc.

As shown in FIGS. 3C and 4A, the pivot pins 114 are located proximate the second end 162 of the slat mount 156 and can be positioned above the chain 140b and/or the chain guide 150b on the second side S1 of the system 100 so that a first segment or portion 174a of the slat 110 extends between the first end 116 of the slat 110 and the pivot pin 114 and a second segment or portion 174b of the slat 110 extends from the pivot pin 114 outwardly from the conveyor 108 toward the second side S2 of the system 100. In embodiments, the pivot pin 114 can be centrally located in the slat 110 so that the segments 174a, 174b of the slat 110 have about the same length. Alternatively, the segments 174a, 174b could have different lengths. In embodiments, each of the slats 110 can include two slat stiffeners 175 mounted along opposing sides of the slat 110 and extending in the transverse direction to the downstream direction M. For example, the stiffeners 175 can be molded and/or otherwise secured to the opposing sides (e.g., the downstream side and the upstream side) of the respective slats 110 for helping to resist and/or prevent any bending and/or breaking of the slats 110. Any of the slats 110, the slat mounts 156, the pivot pins 114, and/or the associated features could be omitted or could be otherwise shaped, positioned, arranged, and/or configured without departing from the disclosure.

As shown in FIGS. 3A-3C, the electromagnets 124 and the ferromagnetic bars 138 (e.g., metal bars including iron, iron alloys, and/or other suitable ferromagnetic materials) can be located on the first side S1 of the system 100 so that the magnetic attraction between the electromagnets 124 and the ferromagnetic bars 138 can resist pivoting of the slats 110 (e.g., upward movement of the first ends 116). In the illustrated embodiments, the electromagnets 124 can be mounted outside the frame plate 120 on the first side S1 of the system 100, opposite to the chain 140a and the chain guide 150a. In embodiments, the electromagnets 124 can be mounted to the first side frame plate 120 via a bracket plate 176. As shown in FIGS. 3A-3C, the ferromagnetic bars 138 can be mounted to the first end 116 of each of the slats 110 (e.g., with mechanical fasteners, adhesive, etc.). In the illustrated embodiments, the ferromagnetic bar 138 can be mounted in a bar recess or notch 178 along the bottom of the slat 110 at the first end 116. As shown in FIG. 3C, the first end 116 of the slat 110 and the ferromagnetic bar 138 can be located along the transverse direction T of the system 100 so that the first end 116 and the ferromagnetic bar 138 are outside the frame plate 120 on the first side of the system 100 and so that the ferromagnetic bars 138 are aligned with the electromagnets 124 in the transverse direction T. As shown in FIG. 3C, of the slats 110 can pass over the electromagnets 124 as the slats 110 move in the downstream direction so that the bottom surface of the ferromagnetic bars 138 are spaced above the electromagnets 124. In embodiments, the spacing between the ferromagnetic bars 138 and the electromagnets 124 can be large enough to provide clearance between the electromagnets 124 and the ferromagnetic bars 138 to help avoid or prevent contact (e.g., dragging) between the ferromagnetic bars 138 and the electromagnets 124, for example. Further, this spacing can be small enough so that the magnetic attraction between the electromagnets 124 and the ferromagnetic bars 138 is sufficient to hold the weight of the second segment 174b of the slat 110 and/or any portion of a package P supported on the second segment 174b so that the magnetic attraction can prevent the first ends 116 of the slats 110 from pivoting upwardly when the electromagnets 124 are in an active condition and the slats 110 pass by the electromagnets 124. Any of the ferromagnetic bars 138, the electromagnets 124, and/or the associated features could be omitted or could be otherwise shaped, positioned, arranged, and/or configured without departing from the disclosure.

As shown in FIGS. 3A-3C, the permanent magnets 134 and the ferromagnetic plates 136 (e.g., metal plates including iron, iron alloys, and/or other suitable ferromagnetic materials) can be aligned on the first side S1 of the system 100 so that the magnetic attraction between the permanent magnets 134 and the ferromagnetic plates 136 can resist pivoting of the slats 110 (e.g., upward movement of the first ends 116). As shown in FIG. 3C, the permanent magnet 134 can be mounted in a magnet recess 180 along the bottom of the respective slat 110 proximate to the first end 116. In embodiments, the magnet recess 180 and the permanent magnet 134 can be spaced inwardly from the first end 116 and the ferromagnetic bar 138 (e.g., so that the magnet recess 180 and the permanent magnet 134 are located between the pivot pin 114 and the first end 116, closer to the first end 116 than to the pivot pin 114, in the transverse direction T). As shown in FIG. 3C, the permanent magnets 134 can be spaced above the ferromagnetic plates 136 to provide clearance between the permanent magnets 134 and the ferromagnetic plates 136 to help avoid or prevent contact (e.g., dragging) between them, for example. Further, the permanent magnets 134 and the ferromagnetic plates 136 can be close enough so that the magnetic attraction between the permanent magnets 134 and the ferromagnetic plates 136 is sufficient to hold the weight of the second segment 174b of the slat 110 and/or any portion of a package P supported on the second segment 174b so that the magnetic attraction can prevent the first ends 116 of the slats 110 from pivoting upwardly when the permanent magnets 134 are moving over the ferromagnetic plates 136.

In the illustrated embodiments, the ferromagnetic plates 136 can be mounted to the frame plate 120 on the first side S1 of the conveyor 108 (e.g., between the frame plate 120 and the electromagnets 124 in the transverse direction T, such as when viewed from the end of the system as shown in FIG. 3C). In embodiments, each of the ferromagnetic plates 136 can be mounted to the frame plate 120 by angle brackets 182 or other suitable mounting features. As shown in FIG. 3C, the ferromagnetic plates 136 can be mounted to the frame plate 120 opposite to the chain guide 150a and the chain 140a (e.g., mounted along the conveyor 108 outside the chains 140a, 140b). As shown in FIGS. 3A and 4B, the ferromagnetic plates 156 can extend along the top of the conveyor 108 with a gap 184 aligned with the one or more electromagnets 124 along the machine direction M. Additional ferromagnetic plates also can be included, such as lower ferromagnetic plates 186, which can extend along the bottom of the conveyor 108, and end ferromagnetic plates 188, which can be curved along the upstream and downstream ends 102, 104 of the conveyor 108 (FIGS. 3A, 4A, and 4B). Any of the ferromagnetic plates 136, 186, 188, the permanent magnets 134, and/or the associated features could be omitted or could be otherwise shaped, positioned, arranged, and/or configured without departing from the disclosure.

As shown in FIGS. 2A-3B and 4A-6, the system 100 can include a rejection ramp 126 positioned along the second side S2 of the system 100 for receiving packages P with nonconforming cartons 20′. In embodiments, the rejection ramp 126 can be mounted to the frame plate 120 on the second side S2 of the system 100, such as by a plurality of ramp mounting brackets 127, opposite to the chain 140b and the chain guide 150b. The rejection ramp 126 can provide a sloped surface for guiding ejected packages to the take-away conveyor 106 (FIG. 6). Open flap sensors 128 (e.g., photoeyes or other suitable sensors) can be positioned at the upstream end 104 or upstream from the system 100 (e.g., as part of the packaging system) and can be configured to detect nonconforming cartons 20′, such as when flaps at one or both ends are improperly glued. A control system 190 (shown schematically in FIG. 2A) can receive signals from the open flap sensors 128 (e.g., when nonconforming cartons 20′ are detected and/or when conforming cartons 20 are detected) and can operate (e.g., energize or deenergize) the electromagnets 124 accordingly. In embodiments, the control system 190 can be in communication with the open flap sensors 128 and the electromagnets 124, such as by a wired connection and/or a wireless connection.

As shown in FIGS. 3C-4B and 6, the system 100 can include a reset surface 130 positioned near the downstream end of the rejection ramp 126. For example, the reset surface 130 can be in the form of a sloped rod, bar, plate, etc. mounted to the frame plate 120 on the second side S2 of the system 100. In embodiments, the reset surface 130 can be sloped upwardly in the machine direction M for guiding the second ends 118 of pivoted slats 110 upwardly to the horizontal position so that the permanent magnets 134 proximate the first ends 116 of the slats 110 can reengage the ferromagnetic plate 136 on the first side S1 of the system 100 (e.g., so that the permanent magnets 134 are sufficiently close to the ferromagnetic plate 136 so that the magnetic force between the permanent magnets and the plate is sufficient to hold the slats 110 in the horizontal position). Any of the features of the system 100 could be omitted or could be otherwise shaped, positioned, arranged, and/or configured without departing from the disclosure.

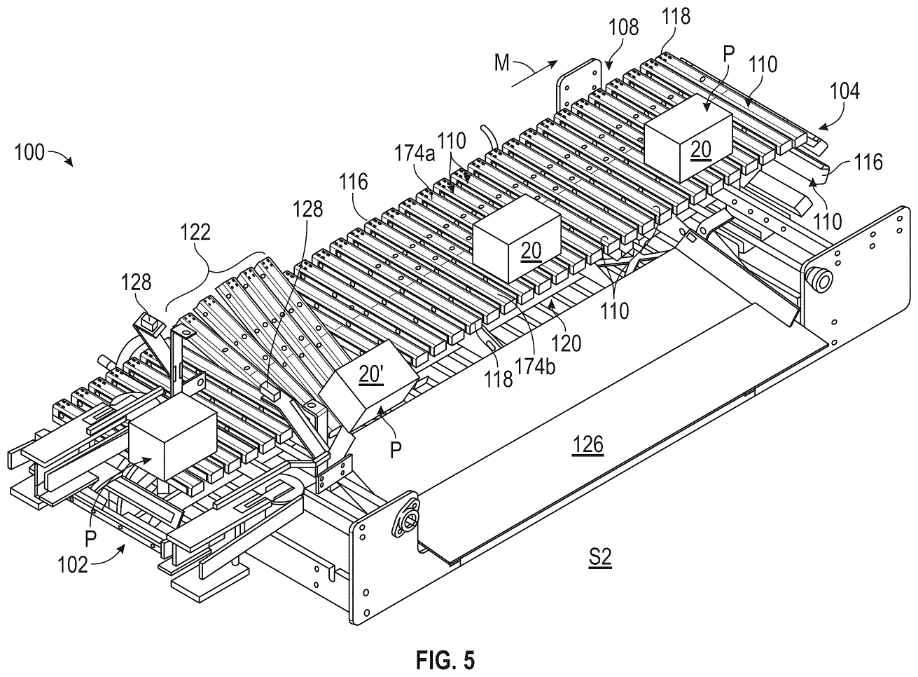

In embodiments, the system 100 can receive packages P at the upstream end 102 (e.g., from any suitable packaging machine or other suitable supply of packages) so that the packages P are positioned on the slats 110 with the center of gravity of each package P being between the second end 118 of the slats 110 and the location where the slats are pivotably mounted to the mount assembly 112 (e.g., at pins 114). In embodiments, each of the packages P can be positioned on a set or grouping of the slats 110, which support and carry the package P in the machine direction M. For example, a package P may be supported on a grouping of three or four slats 110 or any suitable number of slats 110 (e.g., as determined by the size and/or orientation of the package). The permanent magnets 134 can hold the slats 110 in their horizontal position (FIGS. 3A-3C) against the weight of the packages P as the respective grouping of slats 110 moves in the machine direction M, carrying the respective packages P in the machine direction M. In embodiments, the position of the center of gravity of the packages P on the respective groupings of slats 110 can be determined in order to balance the package P so that the magnetic force at the first ends 116 of the slats 110 in the grouping is sufficient to hold the weight of the package P while also resulting in pivoting of the slats 110 in the grouping so that the package P can slide off the slats 110 onto the reject ramp 126 before the slats 110 carry the package past the downstream end of the reject ramp 126 (e.g., at high rates of speed). For example, the farther the center of gravity of the package is from the pivot pins 114 towards the second ends 118, the greater the moment on the slats 110 attempting to cause the slats 110 to pivot so that the first ends 116 tip upwardly and the second ends 118 tip downwardly. Accordingly, a greater magnetic force would be needed at the first ends 116 to hold a package P with a larger moment arm (the distance between the pivot pins 114 and the center of gravity of the package P towards the second ends 116 in the transverse direction) than the same package P positioned to have a smaller moment arm. In embodiments, package P positioned to have a greater moment arm may cause the slats 110 in the respective grouping to pivot to the tilted position (FIGS. 4A-5) faster than packages with a smaller moment arm when the slats 110 are free to tilt as described in more detail below. In exemplary embodiments, a faster tilting speed may be beneficial for ensuring that the slats 110 pivot to the tilted position so that a rejected package slides off the slats 110 onto the reject ramp 126 in the space provided along the conveyor 108 when the conveyor 108 may be moving at high rates of speed (e.g., to match the speed of the upstream packaging system. It may be desirable to choose the moment arm of the packages P so that the weight of the packages can be counteracted by the magnetic force at the first ends 116 of the slats 110 while allowing for a sufficiently fast pivoting of the slats when a package is rejected.

In operation, the slats 110 can move in the machine direction M in the horizontal position (FIGS. 2A-3C). As a particular slat 110 moves from the upstream end 102 of the system 100, the permanent magnet 134 extends over the ferromagnetic plate 136 extending from the upstream end 102 so that the permanent magnet 134 and the ferromagnetic plate 136 are magnetically engaged (e.g., the magnetic attraction between the permanent magnets 134 and the ferromagnetic plate 136 is sufficient to hold the respective slat 110 in the horizontal position). As this slat 110 continues to move in the downstream direction, the permanent magnet 134 moves over the gap 184 between the ferromagnetic plates 136 (e.g., corresponding to a reject area 122) and the permanent magnet 134 is no longer magnetically engaged with one of the ferromagnetic plates 136. While moving in the reject area 122, the ferromagnetic bar 138 of the slat 110 can move over the electromagnets 124, which can be energized (e.g., in an activated condition) to produce a magnetic field and magnetically engage the ferromagnetic bar 138 so that the magnetic force at the first end 116 of the slat 110 holds the slat 110 in the horizontal position. The slat 110 can continue through the reject area 122 past the downstream end of the gap 184 so that the permanent magnet 134 moves over the ferromagnetic plate 136 extending downstream from the gap 184 and the permanent magnet 134 and the ferromagnetic plate 136 become magnetically engaged to hold the slat 110 in the horizontal position as the slat 110 continues to the downstream end 104 of the system 100. In embodiments, the slat 110 can be moved on the conveyor 108 over the downstream wheels 144 (e.g., while the permanent magnet 134 magnetically engages the end ferromagnetic plate 188), can be moved in the upstream direction along the bottom of the conveyor 108 (e.g., while the permanent magnet 134 magnetically engages the lower ferromagnetic plates 186), and then over the upstream wheels 142 to the upstream end 102 of the system 100 (e.g., while the permanent magnet 134 magnetically engages the end ferromagnetic plate 188 at the upstream end).

As long as the packages are not identified as being nonconforming (e.g., the open flap sensors 128 detect a conforming carton 20 and/or do not detect a nonconforming package 20′), the electromagnets 124 remain energized so that the groupings of slats 110 supporting the packages P with conforming cartons 20 are held in the horizonal position through the reject area 122 and the packages P are carried by the slats 110 to the downstream end 104 of the system 100 (FIGS. 2A and 2B).

As shown in FIGS. 4A-6, in the case that a nonconforming carton 20′ is detected by the open flap sensors 128, the control system 190 can deenergize the electromagnets 124 as the grouping of slats 110 engaging/supporting the package P with the nonconforming carton 20′ passes through the reject area 122. Without the magnetic force of the electromagnets 124 at the first ends 116, the weight of the package P pushes down on the second segments 174b of the engaged slats 110 in the grouping so that the slats 110 pivot the first ends 116 upwardly and the second ends 118 downwardly. Accordingly, the slats 110 become sloped toward the rejection ramp 126 and gravity can cause the package P to slide off the slats 110 onto the rejection ramp 126 as the slats 110 continue to move in the machine direction M on the conveyor 108. As shown in FIG. 6, the ejected package can slide down the rejection ramp 126 to the take-away conveyor 106, which can move the ejected package in a direction M′.

In the illustrated embodiments, the control system 190 can receive a signal from the open flap sensors 128 that a nonconforming carton 20′ is detected upstream from the reject area 122. The control system 190 can start a timer so that the grouping of slats 110 supporting the nonconforming carton 20′ is moving through the reject area 122 as the electromagnets 124 are deactivated. In embodiments, the control system 190 can cascade the deactivation of the electromagnets 124 from the upstream end to the downstream end of the reject area 122 so that few or no slats 110 downstream from the grouping of slats supporting the nonconforming carton 20′ are affected. For example, the slats 110 downstream from the grouping pass over energized electromagnets 124 and only the slats 110 in the grouping pass over the deenergized electromagnets 124. Similarly, the control system 190 can cascade the reenergizing of the electromagnets 124 after the slats 110 in the grouping pass over the respective electromagnets 124 so that few or none of the slats 110 upstream from the grouping are affected. For example, the electromagnets 124 can be reenergized as the slats 110 upstream from the nonconforming carton 20′ move over the respective electromagnets 124 so that the upstream slats 110 are held in the horizontal position through the reject area 122 (e.g., as long as the slats 110 upstream from the grouping are not supporting a nonconforming carton 20′). In embodiments, cascading the deenergizing and reenergizing of the electromagnets 124 can reduce the number of slats 110 that are affected by the rejection process (e.g., so that few or no slats 110 upstream or downstream from the grouping of slats 110 supporting the nonconforming carton 20′ are allowed to pivot as they are moved through the reject area 122).

In the illustrated embodiments, as the slats 110 in the grouping supporting the nonconforming carton 20′ pass over the deenergized electromagnets 124 in the reject area 122, the slats 110 in the grouping begin to pivot the first end 116 upwardly and the second end 118 downwardly under the weight of the package P and the package begins to slide off the slats 110 toward the lowered second ends 118 of the slats 110 due to the force of gravity on the package. The conveyor 108 can continue to move the slats 110 in the downstream direction M as the slats 110 pivot to the tilted position. In embodiments, as the pivoting slats 110 move past the downstream end of the reject area 122, the first ends 116 can be moved upwardly sufficiently far so that the magnetic force of the permanent magnets 134 on the ferromagnetic plate 136 that is downstream from the gap 184 is sufficiently weak so that the permanent magnets 134 are not magnetically engaged with the ferromagnetic plate 136 and the slats 110 can continue to pivot to the tilted position as the slats 110 are moved downstream from the reject area 122.

In embodiments, the interior surface of the slat recess 164 of each of the slats 110 can engage the sloped surface of the second end 162 of the slat mount 156 to stop the pivoting of the respective slats 110 (e.g., to stop the downward movement of the second end 118 of the slats) when the slats reach the tilted position shown in FIGS. 4A and 4B. As shown in FIG. 4A, the upper surfaces of the slats 110 can be aligned with the surface of the reject ramp 126 so that the package supported on the tilted slats can move off the slats 110 onto the ramp 126. As shown in FIG. 6, the rejected package P can move down the reject ramp 126 onto the takeaway conveyor 106, which can move the package P (e.g., in a direction M′) to a location where the nonconforming carton 20′ can be corrected and/or the containers in the package can be reclaimed (e.g., returned to a container supply for packaging machine). A downstream sensor (e.g., a photoelectric sensor or other suitable sensor, not shown) can determine if the package P with the nonconforming carton 20′ was successfully rejected (e.g., successfully moved to the takeaway conveyor 106). For example, if the downstream sensor determines that the reject process has failed, the system 100 can be put into a fault state, stopping the conveyor 108. In embodiments, the downstream sensor also can count the number of rejected packages.

As shown in FIG. 6, the tilted slats 110 can engage the reset surface 130 as the slats 110 continue to move in the downstream direction M (e.g., past the downstream end of the reject ramp 126). As the slats 110 are moved in the machine direction M, the second segments 174b of the respective slats 110 can move up the sloped reset surface 130 to pivot the second ends 118 upwardly and the first ends 116 downwardly to move the slats 110 to their horizontal position. As first segment 174a of each of the slats 110 pivoting to the horizontal position moves downwardly, the slat recess 164 can move over the slat mount 156 so that at least the raised portion of the slat mount 156 is at least partially received in the slat recess 164. In the illustrated embodiments, the first end 116 of the slat 110 can continue moving downwardly until the stop surface 166 of the slat 110 engages (e.g., contacts) the slat support surface 158 of the slat mount 156, which stops the pivoting of the slat 110 with the upper surface of the slat 110 in the horizontal position. In embodiments, the permanent magnet 134 can reengage the ferromagnetic plate 136 as the slat 110 moves into the horizontal position so that the magnetic force on the first end 116 of the slat 110 can hold the slat 110 in its horizontal configuration as the slats 110 continue in the downstream direction M.

In exemplary embodiments, the system 100 can be adjusted to accommodate different package sizes and configurations. For example, the pivot point of the slats 110 can be adjusted horizontally in the direction that is transverse to the machine direction M as needed to properly balance and position the packages on the slats (e.g., so that the centers of gravity of the packages are positioned to tilt the slats during a reject process). It is noted that the system 100 can accommodate different package orientations, including packages oriented so that a broad side faces the machine direction. Packaging systems may end-load containers into cartons through the narrower ends of the cartons while the cartons are oriented so that the wider sides are facing the machine direction. The system 100 can receive and handle such cartons without needing to reorient them. Other systems may need to reorient the packages (e.g., so that the narrower ends face the machine direction) before moving the packages in the transverse direction (e.g., to reject a package).

The system 100 can have several advantages over other package rejections systems. For example, the system 100 can be easily added to any suitable packaging system and/or other processing system without requiring major modifications to the upstream packaging system. Other systems may need to be incorporated with significant modification to packaging systems and/or can take up significant space. The system 100 can have a relatively small footprint. Further, the system 100 can operate at high rates of speed (e.g., at over 250 packages per minute, over 350 packages per minute, or other suitable rates) at least because the electromagnets 124 can be rapidly deenergized and energized. Other systems may not be able to operate at high speeds. For example, an overhead reject paddle system attempts to push packages out of the output stream of a packaging system with paddles moving on a conveyor positioned above the packaging system and oblique to the machine direction of the packaging system. Such overhead paddle systems can cause damage to cartons and/or containers of packages and/or can be uncontrolled, which can cause safety issues when operating at higher rates (e.g., at operating rates of packaging systems). Drop conveyor systems can use pistons to move a portion of a conveyor up and down as needed to allow packages to continue on the conveyor or to drop down to a reject conveyor. Drop conveyors can have slow activation of a rejection sequence and can be difficult to operate at production speeds and/or can require significant piston travel for larger packages. In embodiments, the system 100 of the present disclosure can be quieter than other systems, for example, the system 100 can operate using electrical/magnetic components with fewer mechanical components. Other systems relying on mechanical features (e.g., pneumatic pistons, cams, etc.) can be much noisier. The system 100 also can accommodate packages of any suitable size, including smaller packages without needing to eject conforming packages along with nonconforming packages. Other systems may not be able to accommodate smaller packages (e.g., size limits for paddles) and may eject conforming packages along with nonconforming packages.

The above embodiments may be described as having one or more panels adhered together by glue during erection of the carton embodiments. The term “glue” is intended to encompass all manner of adhesives commonly used to secure carton panels in place.

The foregoing description of the disclosure illustrates and describes various embodiments. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, alterations, etc., of the above-described embodiments. Additionally, the disclosure shows and describes only selected embodiments, but various other combinations, modifications, and environments are within the scope of the disclosure as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A method of handling packages, the method comprising:
moving a plurality of slats in a downstream direction so that a portion of each slat of the plurality of slats passes over an electromagnet, wherein each slat of the plurality of slats is pivotable between a horizontal position and a tilted position, and wherein the electromagnet is energized to at least partially hold the slats in the horizontal position as the portions of the respective slats move over the electromagnet;
positioning a package on one or more slats of the plurality of slats so that the package is moved in the downstream direction on the one or more slats;
moving the package off the one or more slats comprising deenergizing the electromagnet while moving the one or more slats past the electromagnet so that the one or more slats supporting the package pivot from the horizontal position to the tilted position so that the package moves off the one or more slats while the one or more slats continue to move in the downstream direction.

2. The method of claim 1, wherein each of the slats comprises a first end and an opposing second end and each of the slats is pivotable between the horizontal position and the tilted position on a pivot pin, and wherein the positioning the package comprises positioning a center of gravity of the package between the pivot pin and the second end of the one or more slats.

3. The method of claim 2, wherein at least a portion of a weight of the package presses down on the one or more slats between the pivot pin and the second end of the one or more slats to cause the second end of the one or more slats to move downwardly during and after the moving the one or more slats past the deenergized electromagnet.

4. The method of claim 2, wherein each of the slats comprises a first segment extending from the first end to the pivot pin and a second segment extending from the second end to the pivot pin, and a ferromagnetic bar is mounted to the first segment of each of the slats, the moving the plurality of slats in the downstream direction comprises moving the ferromagnetic bar of each of the slats over the electromagnet, wherein a magnetic attraction between the electromagnet and the ferromagnetic bars when the electromagnet is energized holds the respective slats in the horizontal position as the slats move past the electromagnet, and wherein the ferromagnetic bars and the first ends of the one or more slats are free to move upwardly relative to the electromagnet as the one or more slats move past the electromagnet when the electromagnet is deenergized.

5. The method of claim 4, wherein a permanent magnet is mounted to the first segment of each of the slats and is spaced apart from the ferromagnetic bar of the respective slat, wherein a plurality of ferromagnetic plates extends along the downstream direction, the electromagnet is aligned with a gap between two ferromagnetic plates of the plurality of ferromagnetic plates, and the permanent magnet of each of the slats is aligned with the ferromagnetic plates when the respective slat is in the horizontal position, and wherein the permanent magnets of the one or more slats are moved away from the ferromagnetic plates when the one or more slats pivot from the horizontal position to the vertical position.

6. The method of claim 1, wherein a reject ramp extends along the downstream direction adjacent the second ends of the slats, and the package moves onto the reject ramp when the package moves off the one or more slats in the tilted position.

7. The method of claim 1, wherein a permanent magnet is mounted to each of the slats, one or more ferromagnetic plates extends along the downstream direction, the permanent magnet of each of the slats is aligned above the one or more ferromagnetic plates when the respective slats are in the horizontal position during a portion of the moving the plurality of slats in the downstream direction.

8. The method of claim 7, wherein the permanent magnets of one or more slats are moved away from the ferromagnetic plates when the one or more slats pivot from the horizontal position to the vertical position.

9. The method of claim 7, wherein the one or more ferromagnetic plates comprises a plurality of ferromagnetic plates, and wherein the electromagnet is aligned with a gap between two ferromagnetic plates of the plurality of ferromagnetic plates.

10. The method of claim 1, wherein the package is a first package and the one or more slats comprises a first grouping of slats, and wherein the method further comprises placing a second package on a second grouping of slats of the plurality of slats, the electromagnet remaining energized while the second grouping of slats move past the electromagnet so that the second grouping of slats remain in the horizontal position while moving in the downstream direction.

11. The method of claim 1, wherein the package includes a nonconforming carton.

12. The method of claim 1, wherein the slats of the plurality of slats are pivotably mounted on respective mount assemblies, and each mount assembly is engaged with one or more chains, and wherein the moving the plurality of slats in the downstream direction comprises moving the one or more chains in the downstream direction so that the one or more chains move the mount assemblies and the slats in the downstream direction.

13. A system for handling packages, the system comprising:
a plurality of slats mounted along a conveyor and moving in a downstream direction of the conveyor, each slat of the plurality of slats being pivotable between a horizontal position and a tilted position; and
an electromagnet mounted along a portion of the conveyor so that a portion of each slat passes over the electromagnet as the slats move in a downstream direction, wherein the electromagnet is operable to be energized to at least partially hold the slats in the horizontal position as the portions of the respective slats move over the electromagnet and to be deenergized to allow pivoting of the slats as the portions of the respective slats move over the deenergized electromagnet;
wherein one or more slats of the plurality of slats supports a package as the slats are moved along the conveyor, and wherein the package moves off the one or more slats when the one or more slats are moved into the tilted position.

14. The system of claim 13, wherein each of the slats comprises a first end and an opposing second end and each of the slats is pivotable between the horizontal position and the tilted position on a pivot pin, and wherein the one or more slats support the package so that a center of gravity of the package is located between the pivot pin and the second end of the one or more slats.

15. The system of claim 14, wherein each of the slats comprises a first segment extending from the first end to the pivot pin and a second segment extending from the second end to the pivot pin, a ferromagnetic bar is mounted to the first segment of each of the slats, and the ferromagnetic bars of the respective slats are aligned with the electromagnet so that the ferromagnetic bars move over the electromagnet when the respective slats move past the electromagnet, wherein a magnetic attraction between the electromagnet and the ferromagnetic bars when the electromagnet is energized holds the respective slats in the horizontal position as the respective slats move past the electromagnet, and wherein the ferromagnetic bars and the first ends of the one or more slats are free to move upwardly relative to the electromagnet as the one or more slats move past the electromagnet when the electromagnet is deenergized.

16. The system of claim 15, wherein a permanent magnet is mounted to the first segment of each of the slats and is spaced apart from the ferromagnetic bar of the respective slat, wherein a plurality of ferromagnetic plates extends along the conveyor, the electromagnet is aligned with a gap between two ferromagnetic plates of the plurality of ferromagnetic plates, and the permanent magnet of each of the slats is aligned with the ferromagnetic plates when the respective slat is in the horizontal position, and wherein the permanent magnets of the one or more slats are moved away from the ferromagnetic plates when the one or more slats pivot from the horizontal position to the vertical position.

17. The system of claim 13, wherein the electromagnet is mounted on a first side of the conveyor and a reject ramp is mounted on a second side of the conveyor adjacent the second ends of the slats, and wherein the package is for moving onto the reject ramp when the package moves off the one or more slats in the tilted position.

18. The system of claim 13, wherein a permanent magnet is mounted to each of the slats, one or more ferromagnetic plates extends along at least a portion of the conveyor, the permanent magnet of each of the slats is aligned above the one or more ferromagnetic plates when the respective slats are in the horizontal position.

19. The system of claim 18, wherein the permanent magnets of one or more slats are for being moved away from the ferromagnetic plates when the one or more slats pivot from the horizontal position to the vertical position.

20. The system of claim 18, wherein the one or more ferromagnetic plates comprises a plurality of ferromagnetic plates, and wherein the electromagnet is aligned with a gap between two ferromagnetic plates of the plurality of ferromagnetic plates.

21. The system of claim 13, wherein the package is a first package and the one or more slats comprises a first grouping of slats, and wherein a second grouping of slats of the plurality of slats supports a second package as the second grouping of slats are moved along the conveyor.

22. The system of claim 13, wherein the package includes a nonconforming carton.

23. The system of claim 13, wherein the conveyor comprises one or more chains moving in the downstream direction, wherein the slats of the plurality of slats are mounted to respective mount assemblies, and the mount assemblies are engaged with the one or more chains so that the one or more chains move the mount assemblies and the respective slats in the downstream direction.

24. The system of claim 23, wherein each of the mount assemblies comprises a slat mount mounted on one or more chain lugs, the one or more chain lugs are supported on the one or more chains, and each of the slats is mounted to the respective slat mount by a pivot pin.
